(19) United States
(12) Patent Application Publication
(10) Pub. No.: US 2006/0213451 A1
(43) Pub. Date: Sep. 28, 2006

(54) Tool for lifting rodent cage tops

(75) Inventor: Jason J. Martin, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Van Andel Research Institute

(21) Appl. No.: 11/087,847

(22) Filed: Mar. 23, 2005

(51) Int. Cl. A01K 31/04

(52) U.S. Cl. 119/471

(57) ABSTRACT

A tool is provided to facilitate lifting and manipulating a top of a rodent cage in an ergonomic manner. The top includes a wire for lifting located away from the top's center of gravity. The tool includes a first end shaped to fit under the wire and engage the top at a location spaced from the wire. The tool further includes a handle extending from the first end toward the center of gravity. The handle is configured to receive a hand of the worker and to generate counterbalancing forces on the wire and top that allow the worker to lift upward on the handle at a location proximate the center of gravity.

### BACKGROUND

The present invention relates to a tool to facilitate ergonomic lifting of a rodent cage top.

Rodents, such as mice, are increasingly used in medical research and laboratory environments for testing. The rodents are typically stored in caging systems built to an industry standard. One such system, shown in FIGS. 1-3, in the present disclosure, and described below, includes a removable wire top with a transverse wire that can be grasped to lift and manipulate the top. The top must often be removed or manipulated to provide access to the rodents, such as for experimentation and animal husbandry, and/or for any general purpose. However, the transverse wire is positioned near an end of the top where a laboratory employee must flex and extend their wrists considerably in order to grasp the transverse wire. Further, since the transverse wire is spaced from a center of gravity of the wire top, the technician must apply a torsional force in order to raise the top with a cantilever force, increasing the stress to the technician's wrist when lifting the top. Still further, many such tops include added features having weight, such as a food basket and/or water bottle, which further adds to the stress of lifting the tops. Still further, the cages are often stacked in a vertical array, with only their narrow end facing outwardly. In this stacked array, the position of the transverse wire is such that the technician has no choice but to place their wrist at an awkward position in order to lift the top. Over time, the combination of awkward gripping, torsional lifting, weight of the top, and limited direction of access can result in fatigue to the technician and possibly may result in a risk of ergonomic injury.

Thus, a system having the aforementioned advantages and solving the aforementioned problems is desired.

### SUMMARY OF THE PRESENT INVENTION

The present invention includes a tool adapted to facilitate lifting and manipulating a top of a rodent cage in an ergonomic manner, where the top has a center of gravity and further has a structural member spaced from the center of gravity such that a worker lifting the top by grasping the structural member experiences a torsional force. The tool includes a configured first end shaped and adapted to releasably fit under the structural member and engage the top at a location spaced from the structural member, and further includes a handle extending from the first end that is adapted to extend toward the center of gravity when the first end is engaged with the structural member. The handle is configured to ergonomically receive and position the hand of the worker and also is located relative to the first end to generate counterbalancing forces through the first end on the structural member and the top in a manner allowing the worker to lift upward on the handle at a location generally above the center of gravity.

In a narrower aspect, the first end includes a first section for engaging the structural member and a second section for abutting the top. The handle extends from the second section “over” the first section to a location where the handle is on an opposite side of the first section from the second section.

In another narrower aspect, the handle is one-piece, constant thickness, and includes an undulating surface adapted to ergonomically receive and engage the fingers of a user to maintain the worker's wrist in a position minimizing radial and ulna deviation.

In another aspect of the present invention, an apparatus is provided that includes, in combination, a rodent caging system and a tool. The rodent caging system includes a cage and a top adapted to removably cover the cage, the top having a center of gravity and further having a structural member spaced from the center of gravity such that a worker lifting the top by grasping the structural member experiences a torsional force. The tool includes a first end that both fits the structural member and engages the top at a location spaced from the structural member, and a handle extending from the first end and that is adapted to extend toward the center of gravity. The handle is configured to receive a hand of the worker and to generate on the structural member and top counterbalancing forces that allow the worker to lift upward on the handle at a location generally above the center of gravity.

In still another aspect of the present invention, a method is provided for lifting and manipulating a top of a rodent cage in an ergonomic manner, where the top has a center of gravity and further has a structural member spaced from the center of gravity such that a worker lifting the top by grasping the structural member experiences a torsional force. The method includes providing a tool having a first end and a handle. The method further includes extending the first end of the tool under the wire and engaging the top at a location spaced from the structural member. Still further, the method includes lifting the handle at a location generally above the center of gravity to generate counterbalancing forces on the structural member and the top that allow the worker to lift upward on the handle without generating substantial torsional forces on the worker's wrist.

Also, the design and appearance of the present tool is considered novel, ornamental, and unobvious.

These and other aspects, objects, and features of the present invention will be understood and appreciated by those skilled in the art upon studying the following specification, claims, and appended drawings.

### BRIEF DESCRIPTION OF DRAWINGS

FIG. 1 is an exploded perspective view showing a prior art rodent caging system including a cage, a top to cover the cage, and a secondary cover adapted to filter air, with the top including a wire (also called a “structural member”) provided for lifting the top;

FIGS. 2-4 are fragmentary side views of the caging system of FIG. 1, FIG. 2 showing the cage, the top, and the secondary cover together, FIG. 3 showing the cage and top only, and FIG. 4 showing removal of the top by traditional means (i.e., a worker's hand);

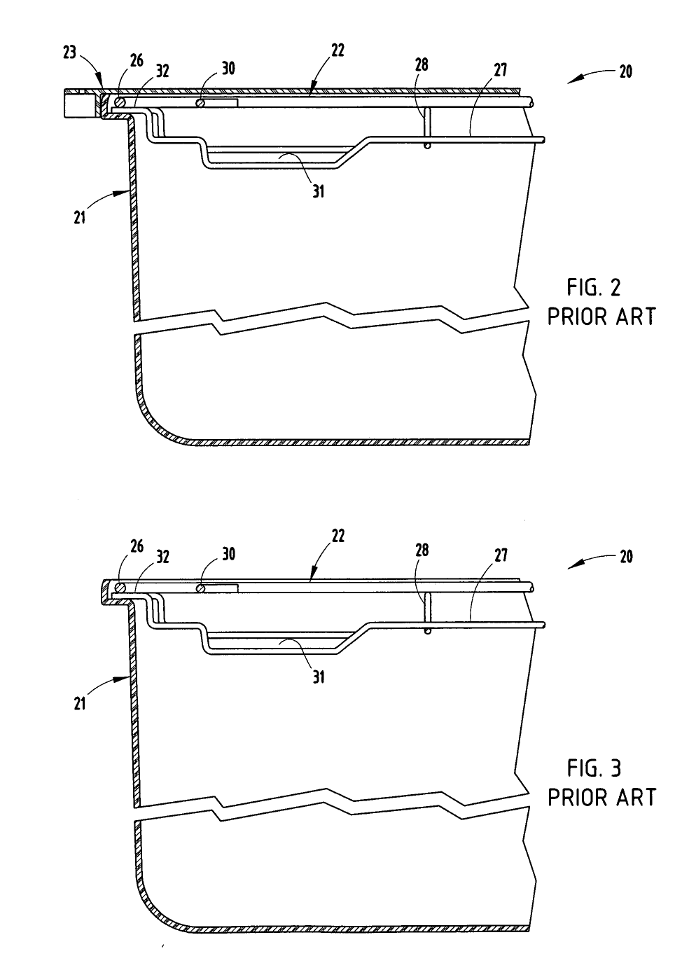

FIG. 5 is a side view showing the present tool engaging the top, and FIG. 5A duplicates FIG. 5 but shows a position of the worker's hand;

FIG. 6 is a side view similar to FIG. 5, but showing the tool lifting the top; and

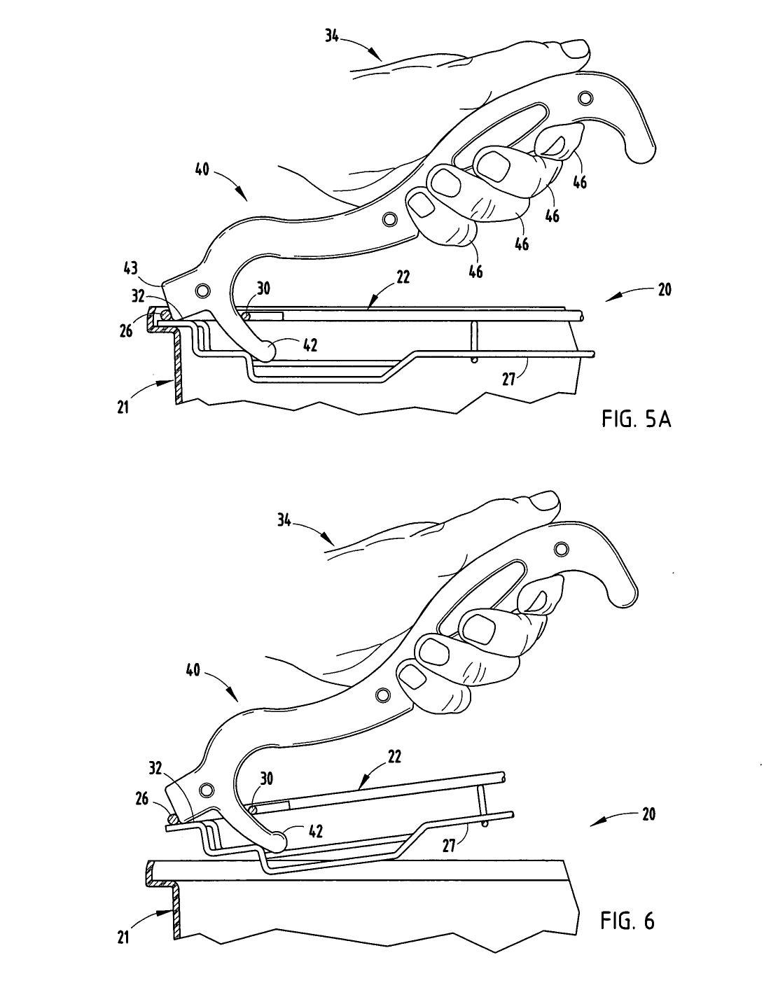

FIGS. 7-8 are side and bottom views of the tool shown in FIGS. 5-7.

### DETAILED DESCRIPTION OF PREFERRED EMBODIMENTS

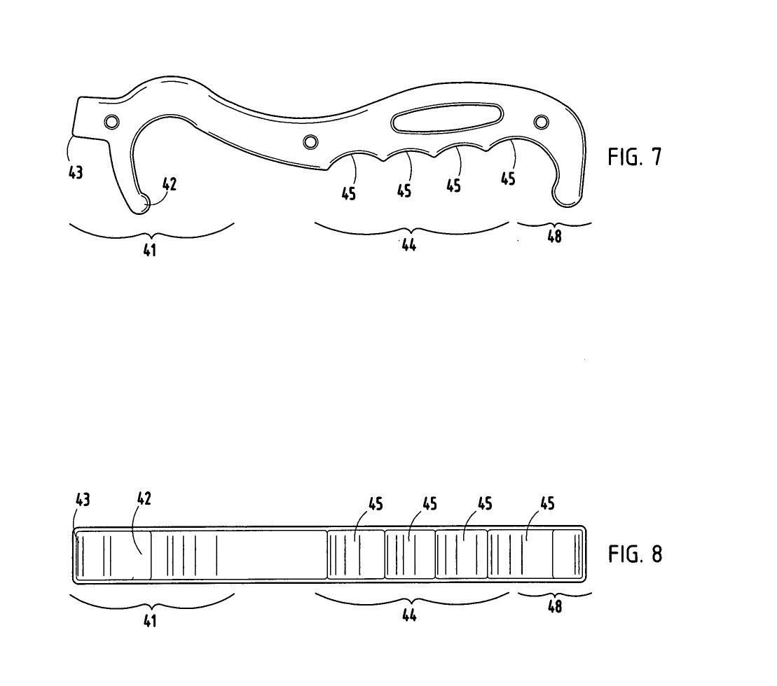

The present ergonomically designed tool is designed to allow lifting and manipulation of rodent cage tops while reducing the stress to a person's wrists. The illustrated tool (FIGS. 7-8) is a hook-shaped device approximately 21 cm long, about 6 cm laterally, and about 2.5 cm in thickness. It is preferably made from a light-weight material such as moldable plastic or aluminum, but could be made from any material of sufficient strength and cleanability and having properties to allow for disinfection (including autoclaving). The tool has a hook-shaped end designed to fit under a wire on the cage's top and to torsionally engage the top at a location offset from the center of gravity of the top, but further includes a handle located generally above the center of gravity when the hook-shaped end is engaged, to thus allow for balanced lifting in a cantilevered arrangement.

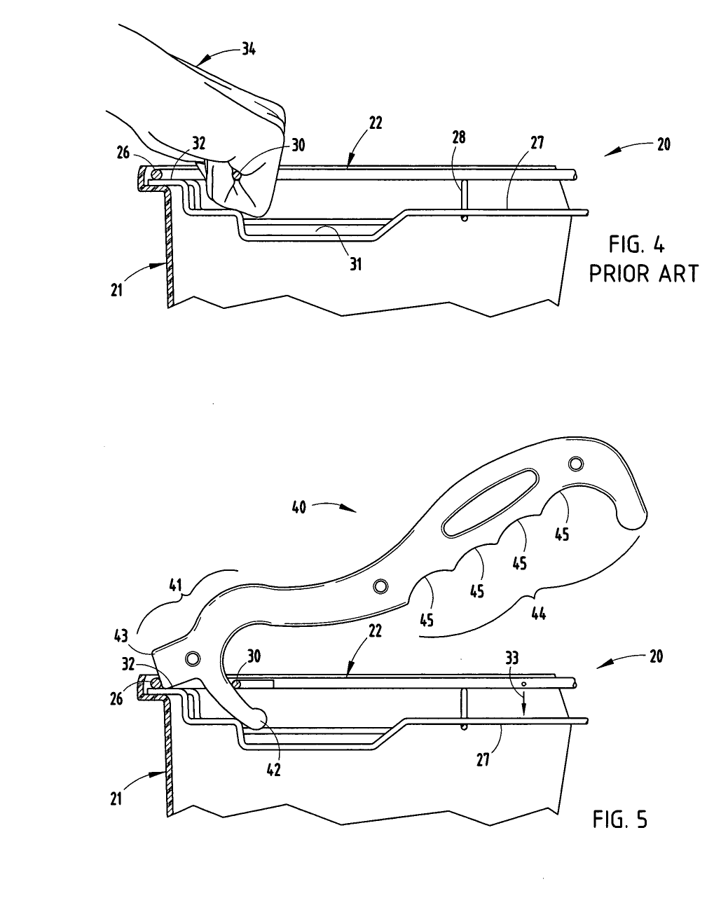

More specifically, the tool allows a worker to change the direction of force(s) applied to the wire top for manipulating the top. This results in changing the muscle groups used to apply the force(s) to lift the top and remove it from a rodent cage, such as for cleaning and to access rodents in the cage. By changing the hand position from a “palm down” position (see FIG. 4) to a more neutral position where the palm faces medially (see FIG. 5A), the user experiences less stress on his/her wrists. In particular, the changed hand position greatly reduces the amount of flexion and extension of the worker's wrist. More technically, the angle of the handle when the tool is operably hooked into the wire top reduces the radial and ulna deviation, thus improving transfer of stresses along the worker's arm in a manner facilitating lifting without adverse effects. Further, the angle of the tool picks up the wire top and keeps the wire top level while maintaining the user's hand and wrist in a neutral position. The top end of the handle has a lip allowing the handle and wire top weight to rest on the index finger of the user, decreasing the amount of grip strength required to use the tool while increasing stability and ease of using the tool.

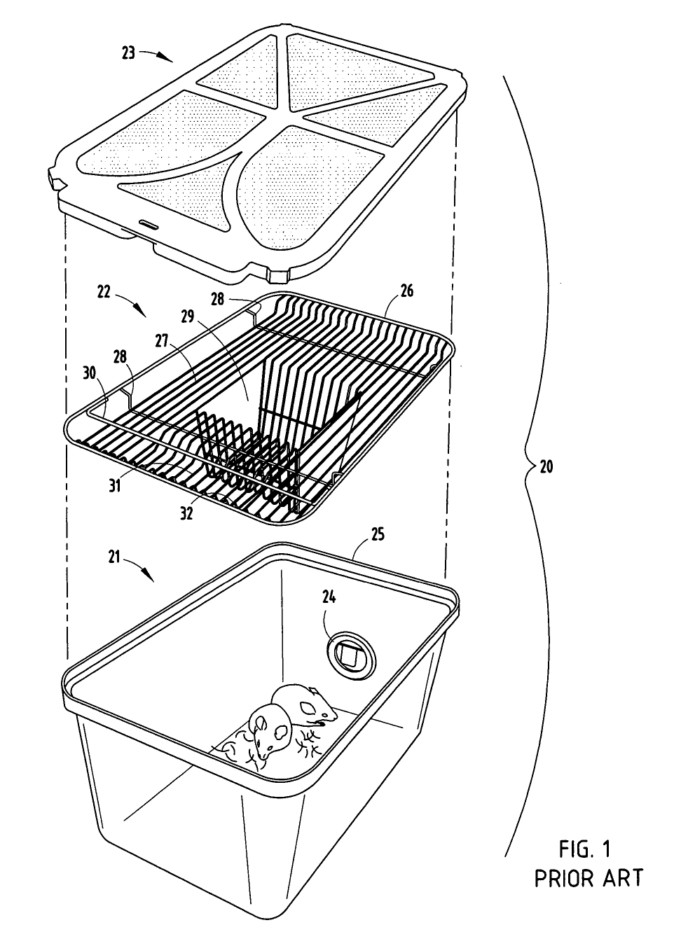

The rodent caging system 20 (FIG. 1) is commercially publicly available, such that the description below is sufficient for an understanding of the present invention. It is contemplated that the present inventive concepts can also be used on other caging systems where it is desirable to lift upwardly on any structural member that is provided on a top at a location spaced from the top's center of gravity.

The caging system 20 includes a molded cage 21, a wire top 22 adapted to removably cover the cage 21, and a filter-containing cover 23 adapted to cover the top 22 such as to provide filtered air to rodents in the cage 21. The illustrated cage 21 is molded of a see-through plastic material so that mice in the cage can be observed. Sidewalls of the cage may include features configured for particular lab needs. The illustrated cage 21 includes an end wall with an opening and bracketry 24 for receiving an automatic watering valve through the end wall. The cage 21 has a lip 25 extending around its upper perimeter that defines a recess for receiving a perimeter/edge of the top 22. Like the cage 21, the top 22 can be adapted to include particular features. The illustrated top 22 includes a food-holding basket 29 formed generally in its center. The top 22 is made from a perimeter wire 26 bent into a rectangular loop and shaped to fit into the recess of the top lip 25 of the cage 21. A plurality of smaller-diameter wires 27 extend in parallel across the top between opposing portions of the perimeter wire 26. The wires 27 are supported by stabilizer wires 28 that extend perpendicularly, with wires 26-28 being welded or soldered together to form a unitary assembly. The wires 27 extend from the perimeter wire 26 inwardly, then downwardly, and then horizontally across the top 22. The food-holding basket 29 is formed in a center of the top 22 by forming the wires 27 downwardly across the region of the basket 29. Sheet metal panels are added as needed to fully form the basket 29.

A transverse wire 30 (FIG. 1) (also called a “structural member” herein) extends across the top 22 at a location near one end of the top 22. The wire 30 is spaced from the perimeter wire 26. The wires 27 are bent to form a recess 31 under a center of the wire 30, and a ledge 32 located between the recess 31 and the perimeter wire 26. As shown in FIG. 4, the purpose of the wire 30 and recess 31 is to allow a worker to extend his/her fingers into the recess 31 and pull upwardly on the wire 30 in order to remove the top 22 from the cage 21. However, as is quickly apparent based on the location of the center of gravity 33 relative to the wire 30, this results in an unstable condition, such that a torsional force must be applied by the user's hand and wrist 34 in order to lift the top 22. This is not a desirable arrangement, since it can in some circumstances result in ergonomic stress and possibly even injury, such as a carpal-tunnel type injury, as discussed under the subtitle “BACKGROUND” above.

The tool 40 (FIG. 5) includes a first end 41 with a hook-shaped tip 42 adapted to fit under the wire 30. The end 41 further includes an abutment section 43 configured to engage the ledge 32 just inside the perimeter wire 26. The abutment section 43 is wide enough to engage at least a pair of the parallel wires 37, such that the tip 42 and abutment section 43 stably engage the wire 30 and ledge 32. The tool 40 further includes a handle 44 that extends from the abutment section 43 to a location on the other side of the tip 42. An undulating surface 45 forms recesses for the fingers 46 (FIG. 5A) of the worker. Notably, the undulating surface 45 (FIG. 5) is generally above the center of gravity 33 when the first end 41 is engaged with the wire 30 and ledge 32. This allows the worker to lift upwardly with his/her hand at a location generally directly above the center of gravity 33, while the tool generates a torsional lifting force at the wire 30 and ledge 32 for lifting the top 22. By this arrangement, the handle 44 and end 41 form a cantilevered arrangement permitting lifting of the top 22 at (above) the center of gravity 33, while gripping the top 22 at a location spaced horizontally from its center of gravity 33. Since the lifting force is above the center of gravity 33, torsional loads on the user's wrist and fingers are substantially eliminated. Also, the user's hand is oriented in a much more ergonomic position with minimal radial and ulna deviation, resulting in less risk of injury. It is noted that the worker may use his/her thumb on the tool for stability, but in use, the lifting forces are so balanced and well controlled by the worker's fingers that very little, if any, thumb force on the handle 44 is needed. Also, the motion to engage the first end 41 with the wire 30 is a smooth and simple forward translational motion over the cage as the first end 41 is lowered into the space below the wire 30. The engagement is surprisingly simple and secure, and does not require multiple or complex manipulation in order to engage (or release) the tool 40 from the top 22.

The tail end 48 (FIG. 7) is “J” shaped, similar to the shape of the first end 41 described above. The shape of tail end 48 allows the tool to be reversed with the tail end 48 engaging the wire 30 and ledge 32, which positions the handle 44 in a second alternative position that may be desirable in some circumstances and for some lab employees.

It is contemplated that the ends 41 and 48 of the present tool could be modified, if desired. For example, the abutment section 43 can be extended transversely to span several of the wires 37 in the top 22 so that it is even more stable when engaging the top 22. Alternatively, it is contemplated that the abutment section 43 could be made narrow enough such that it slips between a pair of adjacent wires 37. In one variation, it is contemplated that the abutment section 43 could be made to snap interlockingly between an adjacent pair of wires 37 so that the tool 40 is frictionally securely held in place during use. The abutment section 43 could be disengaged by counter-rotation of the tool 40 (i.e., a motion opposite the lifting motion) so that the tip 42 engages the top 22 causing an upward (releasing) force on the abutment section 43. Still further, the inside surface of the hook-shaped tip 42 could be modified to include a notch to receive the wire 30, or could be modified to laterally releasably hookingly engage one or more of the wires 37 to provide the upward lifting force on the top 22.

It is contemplated that the tool 40 can be modified to reduce weight and still accomplish the desired task of releasably engaging a top 22 at a position offset from its center of gravity 33 while still allowing the lifting force to be applied generally over the top's center of gravity 33 and while keeping the handle 44 in a desired orientation. The illustrated tool 40 includes several apertures therein to reduce its weight. It is contemplated that additional weight could be removed by including more apertures in the tool, or by minimizing the tool's length, or by making cross-sectional portions of the tool thinner (i.e., thickness and width).

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A tool to facilitate lifting and manipulating a top of a rodent cage in an ergonomic manner, the top having a center of gravity and further having a structural member spaced from the center of gravity such that a worker lifting the top by grasping the structural member experiences a torsional force, comprising:
a configured first end shaped and adapted to releasably fit under the structural member and engage the top at a location spaced from the structural member, and a handle extending from the first end that is adapted to extend toward the center of gravity when the first end is engaged with the structural member, the handle being configured to ergonomically receive and position a hand of the worker and also being located relative to the first end to generate counterbalancing forces through the first end on the structural member and the top, allowing the worker to lift upward on the handle at a location generally above the center of gravity.

2. The tool defined in claim 1, wherein the first end includes a first section adapted to engage the structural member and a second section adapted to abut the top when the first section is engaged and when lifting the handle.

3. The tool defined in claim 2, wherein the handle extends from the second section.

4. The tool defined in claim 3, wherein the first and second sections and the handle form a J-shaped arrangement.

5. The tool defined in claim 4, wherein the first end and the handle are integrally formed as one piece.

6. The tool defined in claim 5, wherein the one piece has a constant thickness.

7. The tool defined in claim 1, wherein the handle includes an undulating surface adapted to receive and engage fingers of user.

8. The tool defined in claim 1, wherein the first end and the handle form a J-shaped arrangement.

9. The tool defined in claim 1, wherein the first end and the handle are integrally formed as one piece.

10. The tool defined in claim 1, wherein the configured first end includes a concavely shaped inner surface adapted to stably engage the structural member when the first end is positioned under the structural member, and further includes a protruding section on an outer surface adapted to stably engage the top near to but spaced from the structural member.

11. An apparatus comprising in combination:
a rodent caging system including a cage and a top adapted to removably cover the cage, the top having a center of gravity and further having a structural member spaced from the center of gravity such that a worker lifting the top by grasping the structural member experiences a torsional force; and
a tool including a first end that both fits under the structural member and engages the top at a location spaced from the structural member, and a handle extending from the first end and that is adapted to extend toward the center of gravity, the handle being configured to receive a hand of the worker and to generate on the structural member and top counterbalancing forces that allow the worker to lift upward on the handle at a location generally above the center of gravity.

12. The apparatus defined in claim 11, wherein the top includes a cage-covering section for covering the cage, and wherein the structural member is spaced above the cage-covering section, the first end being shaped to fit under the structural member and engage the body at a location spaced from the structural member.

13. The apparatus defined in claim 11, wherein the tool is a one-piece component.

14. The apparatus defined in claim 11, wherein the tool is J-shaped.

15. The apparatus defined in claim 11, wherein the tool has a curved end forming a hook for engaging the structural member.

16. The apparatus defined in claim 11, wherein the first end removably engages the structural member and the top.

17. A method for lifting and manipulating a top of a rodent cage in an ergonomic manner, the top having a center of gravity and further having a structural member spaced from the center of gravity such that a worker lifting the top by grasping the structural member experiences a torsional force, comprising steps of:
providing a tool having a first end and a handle;
extending the first end of the tool under the structural member and engaging the top at a location spaced from the structural member; and
lifting the handle at a location generally above the center of gravity to generate counterbalancing forces on the structural member and top that allow the worker to lift upward on the handle without generating substantial torsional forces on the worker's wrist.

18. The method defined in claim 17, wherein the step of extending includes moving the handle across the structural member toward the center of gravity and, while doing so, slipping a first section of the first end under the structural member.

19. The method defined in claim 18, wherein the step of extending includes lowering the first end as the handle is moved across the structural member, such that the first end engages the structural member with a continuous translating motion.

20. The method defined in claim 17, wherein the handle includes a surface configured to receive the worker's hand, and wherein the step of lifting includes grasping the handle on the surface while maintaining the worker's wrist with minimal radial and ulna deviation in order to minimize undesirable ergonomic stresses on the worker's wrist and forearm.
